(19) United States
(12) Patent Application Publication
(10) Pub. No.: US 2026/0146977 A1
(43) Pub. Date: May 28, 2026

(54) DILUTING SAMPLES IN A SAMPLE MANAGER WHEN USING LIQUID CHROMATOGRAPHY TESTING

(71) Applicant: Waters Technologies Corporation, Milford, MA (US)

(72) Inventors: Sylvain Gilles Cormier, Charlton, MA (US); David Zielinski, Arlington, MA (US); Paul Keenan, Harrisville, RI (US); Christian Zeigler, Medford, MA (US); Michael O. Fogwill, Uxbridge, MA (US); Ari Frayne, Milford, MA (US)

(21) Appl. No.: 19/400,659

(22) Filed: Nov. 25, 2025

Related U.S. Application Data
(60) Provisional application No. 63/725,361, filed on Nov. 26, 2024.

(51) Int. Cl. G01N 30/24; G01N 1/38; G01N 30/02; G01N 30/72

(52) U.S. Cl. CPC G01N 30/24; G01N 1/38; G01N 30/7233; G01N 2001/383; G01N 2030/027

(57) ABSTRACT

A method for performing liquid chromatography includes receiving, by a receptor of a liquid chromatography sample manager, a sample vial containing a sample; drawing, by an automated needle system of the liquid chromatography sample manager, the sample from the sample container; and diluting, by the automated needle system of the liquid chromatography sample manager, the sample using a dilution system that is self-contained within the sample fluidics of the liquid chromatography sample manager. A liquid chromatography sample manager and/or liquid chromatography system including a sample manager is further provided that is configured to perform the method.

### RELATED APPLICATION

This application claims priority to U.S. Provisional Patent Application No. 63/725,361 filed on Nov. 26, 2024 and titled “Diluting Samples in a Sample Manager when Using Liquid Chromatography Testing” then entirety of which is incorporated herein by reference.

### FIELD OF THE INVENTION

The disclosed technology generally relates to liquid chromatography. More particularly, the technology relates to methods and systems for diluting samples or injectable substances in an automated sample manager when using liquid chromatography (LC) testing.

### BACKGROUND

There is a need in the art of liquid chromatography (LC) for improved solutions to apply in quality assurance and quality control (QA/QC) labs for injectable substances. Injectable substance samples often require dilution and injection to complete the QA/QC parts of the manufacturing process. Traditional workflows require manual or automated dilution of the final product followed by injection into an LC system. This requires several manual transfers from an original packaging to a dilution container, and from a dilution container to LC vials which are then placed on instrument trays which are finally put into an LC sample manager. All of this takes time and increases the possibility of error through manual intervention.

Therefore, improved devices and methods for performing LC testing on injectable substances with dilution would be well received in the art.

### SUMMARY

In one aspect, a method for performing liquid chromatography includes receiving, by a receptor of a liquid chromatography sample manager, a sample container containing an sample; drawing, by an automated needle system of the liquid chromatography sample manager, the sample from the sample container; and diluting, by the automated needle system of the liquid chromatography sample manager, the sample using a dilution system that is self-contained within the sample fluidics of the liquid chromatography sample manager.

Additionally or alternatively, the automated needle system includes a first syringe drive including a sample needle and a second syringe drive, wherein the drawing the injectable substance from the sample container is performed by the sample needle of the first syringe drive.

Additionally or alternatively, the method includes drawing, by the second syringe drive, a diluent used during the diluting the sample.

Additionally or alternatively, the method includes at least one of: dispensing, by each of the sample needle of the first syringe drive and the second syringe drive, the sample and the diluent simultaneously at flow rates dictated by a dilution factor; and dispensing, by each of the sample needle of the first syringe drive and the second syringe drive, the sample and the diluent sequentially at volumes dictated by the dilution factor.

Additionally or alternatively, the method includes storing, in a storage loop of the automated system of the liquid chromatography sample manager, the diluted sample.

Additionally or alternatively, the method includes moving the diluted sample back and forth within the storage loop to promote mixing.

Additionally or alternatively, the method includes drawing the diluted sample from the storage loop; and injecting the diluted sample into a chromatography stream.

Additionally or alternatively, the method includes storing, in a dilution tower connected to at least one of the first syringe drive and the second syringe drive, the diluted sample.

Additionally or alternatively, the method includes moving the diluted sample and/or the dilution tower back and forth to promote mixing.

Additionally or alternatively, the method includes drawing the diluted sample, by at least one of the first syringe drive and the second syringe drive, from the dilution tower; and injecting the diluted sample into a chromatography stream.

Additionally or alternatively, the sample vial is an original capped vial and wherein the sample is an injectable substance.

Additionally or alternatively, the diluting further includes serially diluting the sample by performing at least a first dilution sequence and a second dilution sequence, wherein the diluted sample is provided back into the dilution system after the first dilution sequence for the second dilution sequence.

In another aspect, a liquid chromatography sample manager includes a receptor configured to receive a sample container containing a sample; and an automated needle system configured to, without human intervention: draw the sample from the sample container; and dilute the sample using a dilution system that is self-contained within the sample fluidics of the liquid chromatography sample manager.

Additionally or alternatively, the automated needle system includes a first syringe drive including a sample needle and a second syringe drive, wherein the sample needle of the first syringe drive is configured to draw the injectable substance from the sample container.

Additionally or alternatively, the second syringe drive is configured to draw a diluent used during the diluting the sample.

Additionally or alternatively, the automated needle system is further configured to at least one of: dispense, by each of the sample needle of the first syringe drive and the second syringe drive, the sample and the diluent simultaneously at flow rates dictated by a dilution factor; and dispense, by each of the sample needle of the first syringe drive and the second syringe drive, the sample and the diluent sequentially at volumes dictated by the dilution factor.

Additionally or alternatively, the sample manager further includes a storage loop in fluidic communication with at least one of the first syringe drive and the second syringe drive, wherein the storage loop is configured to store the diluted sample.

Additionally or alternatively, the sample manager is further configured to move the diluted sample back and forth within the storage loop to promote mixing.

Additionally or alternatively, the automated needle system is further configured to: draw the diluted sample from the storage loop; and inject the diluted sample into a chromatography stream.

Additionally or alternatively, the sample manager further includes a dilution tower connected to at least one of the first syringe drive and the second syringe drive, wherein the dilution tower is configured to receive and/or store the diluted sample.

Additionally or alternatively, the dilution tower is configured to be moved back and forth to promote mixing of the diluted sample.

Additionally or alternatively, the automated needle system is further configured to: draw the diluted sample from the dilution tower; and inject the diluted sample into a chromatography stream.

Additionally or alternatively, the sample container is an original capped vial and wherein the sample is an injectable substance.

Additionally or alternatively, the automated needle system is further configured to serially dilute the sample by performing at least a first dilution sequence and a second dilution sequence, wherein the diluted sample is provided back into the dilution system after the first dilution sequence for the second dilution sequence.

In another aspect, a liquid chromatography system includes a liquid chromatography sample manager having a receptor configured to receive a sample container containing a sample; and an automated needle system configured to, without human intervention: draw the sample from the sample container; and dilute the sample using a dilution system that is self-contained within the sample fluidics of the liquid chromatography sample manager. The liquid chromatography system further includes a solvent delivery system in fluidic communication with the liquid chromatography sample manager; a chromatography column located downstream from the liquid chromatography sample manager; and a detector located downstream from the chromatography column.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts a schematic representation of a liquid chromatography system, in accordance with one embodiment.

FIG. 2 depicts a workflow for injectable substances when using liquid chromatography testing in accordance with a prior art method.

FIG. 3 depicts a workflow for injectable substances when using liquid chromatography testing, in accordance with one embodiment.

FIG. 4 depicts a plurality of original capped vials containing injectable substances, in accordance with one embodiment.

FIG. 5A depicts an original capped vial being interacted with by a needle drive system, in accordance with one embodiment.

FIG. 5B depicts a top view of an original capped vial showing a septa, in accordance with one embodiment.

FIG. 5C depicts an enlarged top view of the original capped vial showing the septa, in accordance with one embodiment.

FIG. 6 depicts a schematic flow diagram of a sample manager for a liquid chromatography system, in accordance with one embodiment.

FIG. 7 depicts a schematic flow diagram of a sample manager for a liquid chromatography system, in accordance with one embodiment.

FIG. 8 depicts a method for diluting a sample for liquid chromatography processing, in accordance with one embodiment.

FIG. 9 depicts another method for diluting a sample for liquid chromatography processing, in accordance with one embodiment.

FIG. 10 depicts another method for diluting a sample for liquid chromatography processing, in accordance with one embodiment.

FIG. 11 depicts another method for diluting a sample for liquid chromatography processing, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments described herein provide for creating a sample manager that is capable of performing sampling, vial puncturing, and sample drawing from the original injectable packaging, followed by the dilution of the production liquid and injection of the diluted sample. The automation of the dilution into the sample manager as disclosed herein is configured to minimize errors cause by human intervention and improve the overall performance of the LC system and the ensuing results.

Thus, embodiments described herein below provide for a sample manager with the ability to draw an injectable substance or sample from an original capped vial (i.e. final packaging) or sample container and dilute the sample and inject the sample into a liquid chromatograph using a self-contained dilution system. “Self-contained” herein means a dilution system within the sample fluidics of the sample manager without the need for additional empty dilution vials. Rather, embodiments described herein contemplate inserting a sample (i.e. injectable substance) in a sample container (i.e. original capped vial) into a sample manager system and performing dilution using only the self-contained components such as an internal storage loop and/or dilution tower within the sample manager system, without requiring additional empty containers being inserted into the system by a technician to be used during the dilution process. The present invention further contemplates a wash system whereby the dilution system (i.e. the sample loop and/or dilution tower) will be washed after every dilution sequence or stage in order to make such self-contained dilution components reusable for the dilution processes described herein.

Embodiments further include flow through needle injections, and injections at dilution factors of at least 250. Advantageously, embodiments described herein provide for minimized oxidation of the sample during dilution and injection. Washing after each dilution sequence may include washing the dilution system to a standard so that less than 0.005% or less (e.g., 0.004%, 0.003%, 0.002%) units of response carry over are residually found within the dilution system components (i.e., needles, fluidic paths, storage loops and/or dilution towers, etc.).

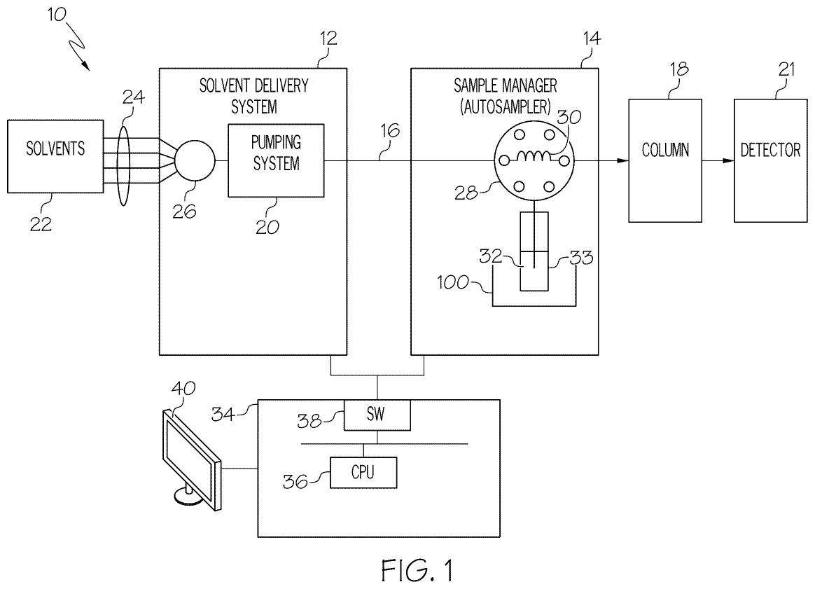

The features of the sample delivery system and sample manager described herein may be applicable to any liquid chromatography system configured to deliver samples into a chromatographic flow stream. As one example, FIG. 1 shows an embodiment of a liquid chromatography system 10 for separating a mixture into its constituents. The liquid chromatography system 10 includes a solvent delivery system 12 in fluidic communication with a sample manager 14 (also called an injector or an autosampler) through tubing 16. The sample manager 14 is in fluidic communication with a chromatographic column 18. A detector 21 for example, a mass spectrometer, is in fluidic communication with the column 18 to receive the elution.

The solvent delivery system 12 includes a pumping system 20 in fluidic communication with solvent reservoirs 22 from which the pumping system 20 draws solvents (liquid) through tubing 24. In one embodiment, the pumping system 20 is embodied by a low-pressure mixing gradient pumping system having two pumps fluidically connected in series. In the low-pressure gradient pumping system, the mixing of solvents occurs before the pump, and the solvent delivery system 12 has a mixer 26 in fluidic communication with the solvent reservoirs 22 to receive various solvents in metered proportions. This mixing of solvents (mobile phase) composition that varies over time (i.e., the gradient).

The pumping system 20 is in fluidic communication with the mixer 26 to draw a continuous flow of gradient therefrom for delivery to the sample manager 14. Examples of solvent delivery systems that can be used to implement the solvent delivery system 12 include, but are not limited to, the ACQUITY Binary Solvent Manager and the ACQUITY Quaternary Solvent Manager, manufactured by Waters Corp. of Milford, Mass.

The sample manager 14 may include an injector valve 28 having a sample loop 30. The sample manager 14 operates in one of two states: a load state and an injection state. In the load state, the position of the injector valve 28 is such that the sample manager loads the sample 32 into the sample loop 30. The sample 32 is drawn from a vial contained by a sample vial carrier. “Sample vial carrier” herein means any device configured to carry a sample vial such as a well plate, sample vial carrier, or the like. In the injection state, the position of the injector valve 28 changes so that the sample manager 14 introduces the sample in the sample loop 30 into the continuously flowing mobile phase from the solvent delivery system. The mobile phase thus carries the sample into the column 18. In other embodiments, a flow through needle (FTN) may be utilized instead of a Fixed-Loop sample manager. Using an FTN approach, the sample may be pulled into the needle and then the needle may be moved into a seal. The valve may then be switched to make the needle in-line with the solvent delivery system.

The liquid chromatography system 10 further includes a data system 34 that is in signal communication with the solvent delivery system 12 and the sample manager 14. The data system 34 has a processor 36 and a switch 38 (e.g. an Ethernet switch) for handling signal communication between the solvent delivery system 12 and sample manager 14, as described herein. Signal communication among the various systems and instruments can be electrical or optical, using wireless or wired transmission. A host computing system 40 is in communication with the data system 34 by which a technician can download various parameters and profiles (e.g., an intake velocity profile) to the data system 34.

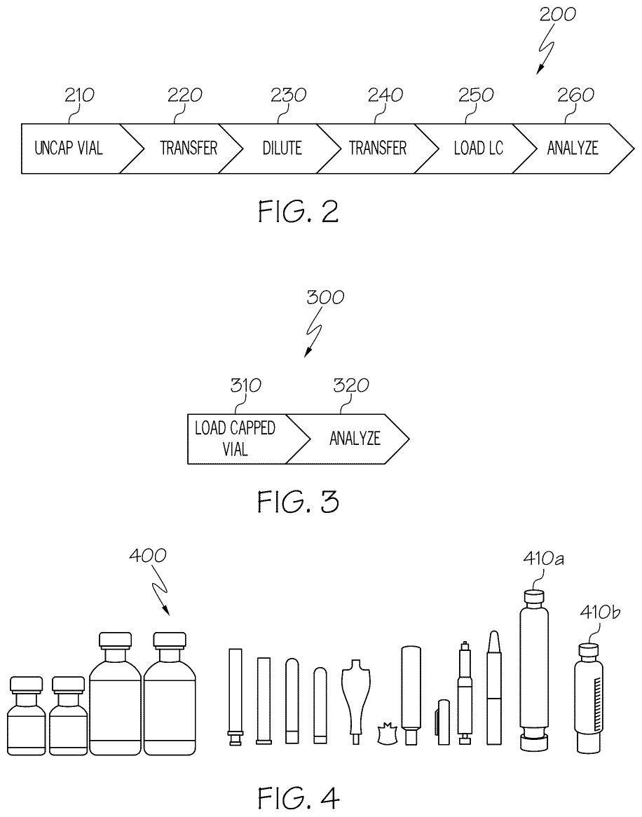

FIG. 2 depicts a workflow 200 for injectable substances when using liquid chromatography testing in accordance with a prior art method. As shown, the various steps in a prior art workflow require manual intervention at various stages, including a first stage 210 of uncapping the vial, a second stage 220 of placing some of the sample in a dilution container. A third stage 230 of the workflow 200 includes diluting the sample in the dilution container. Once diluted, the diluted sample is then transferred at a fourth stage 240 into a container that is capable of being interacted with by a liquid chromatography system. Then a fifth stage 250 includes loading such a container, containing the diluted sample, into the liquid chromatography system. Finally, the diluted sample is analyzed at a sixth stage 260. In such a workflow, the manual stages 210, 220, 230, 240 in particular are error prone, incur high labor cost, and are especially painful when the sample is light-sensitive, for example. In many instances, it has been shown that high error rates result in such a manual system.

FIG. 3 depicts a workflow 300 for injectable substances or samples when using liquid chromatography testing, in accordance with one embodiment. In contrast to the prior art workflow 200, the workflow 300 contemplated by the present invention includes a first stage 310 of loading an original capped vial or sample container containing an injectable substance or sample into a sample manager or other automated system, such as the sample manager 14. The workflow 300 then includes using the automation within the sample manager 14 to simply process and analyze the injectable substance or sample in a second and final stage 320, without any human intervention or interaction (other than the placing of the original capped vial or sample container into the sample manager). To enable direct analysis from the formulated injectable, the LC sample compartment may be (as described herein below): adapted to pierce the vial septum; modified to include a dilution system; and including a reception system that is increased in height to accept tall injectable vials.

FIG. 4 depicts a plurality of original capped vials 400 containing injectable substances, in accordance with one embodiment. As shown, an “original capped vial” as defined herein means a capped vial containing an injectable substance in its original packaged form, as produced by the injectable manufacturer. The “original capped vial” as defined herein is in a vial that is configured for performing injection by a medical provider or professional using the original capped vial. Various examples of vials are shown in FIG. 4 which fit this definition. For example, a first capped vial 410a is shown having a relatively tall container or vial. Another shorter capped vial 410b is also shown. In various embodiments, the “original capped vials” described herein may have a height of 100 mm, 110 mm, 120 mm or more, for example. Accepting vials of such heights may require the raising of receiver systems in prior art LC processing systems and sample managers.

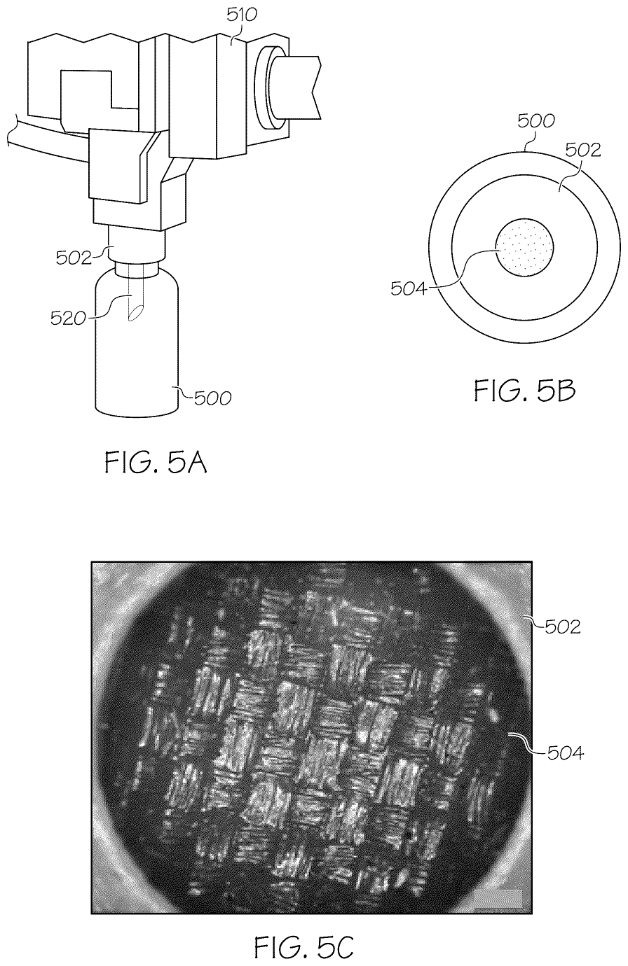

FIG. 5A depicts a original capped vial 500 being interacted with by a needle drive system 510, in accordance with one embodiment. As shown, a puncture needle 520 has been inserted through a top cap 502 of the original capped vial 500. FIG. 5B depicts a top view of the original capped vial 500 showing a septa 504 which is configured to be punctured by the puncture needle 520, in accordance with one embodiment. FIG. 5C depicts an enlarged top view of the original capped vial 500 showing the material of the septa 504, in accordance with one embodiment.

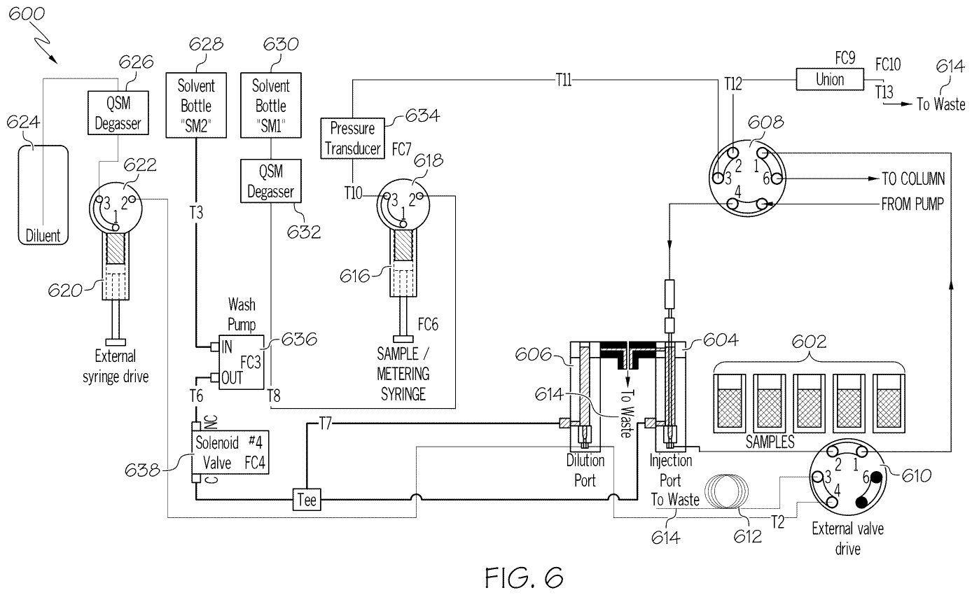

FIG. 6 depicts a schematic flow diagram of a sample manager 600 for a liquid chromatography system, in accordance with one embodiment. The sample manager 600 includes various components configured to process and/or dilute, without human intervention, one or more samples 602 using the methodology or workflow described herein. While not specifically shown, the sample manager 600 may include a receptor system configured to receive the original capped vials 602 or sample container for processing therein.

The sample manager 600 includes a first syringe drive system 604 and a second syringe drive system 606. The first syringe drive system 604 may include a sample needle and puncture needle (not shown) for flow through needle injections into the liquid chromatography solvent flow for separation and/or analysis and/or detection. Thus, the sample needle of the first syringe drive system 604 may be configured to draw the injectable substance from the original capped vial 602 or sample container. The second syringe drive system 606 may be configured to draw diluent used during the diluting the injectable substance or sample.

The combination of the first syringe drive system 604 and the second syringe drive system 606 may be referred to herein as an automated needle system. Such a system may be configured to, in combination, dispense the sample and the diluent simultaneously at flow rates dictated by a dilution factor and/or dispense, by each of the sample needle of the first syringe drive 604 and the second syringe drive 606, the sample and the diluent sequentially at volumes dictated by the dilution factor.

The automated needle system may further include a plurality of ports 608, 610 in fluidic communication therewith for directing fluid flow. Moreover, as shown, the automated needle system and/or the sample manager 600 includes a storage loop 612 a storage loop in fluidic communication with at least one of the first syringe drive 604 and the second syringe drive 606, wherein the storage loop 612 is configured to store the diluted injectable substance or sample. The sample manager 600 system may be configured to pump the diluted injectable substance or sample back and forth within the storage loop 612 to promote mixing. The sample manager 600 may further include at least one waste channel 614, including a waste channel 614 connected fluidically to the storage loop 612. The sample manager 600 and/or the automated system thereof may further be configured to draw the diluted sample from the storage loop 612 and inject the diluted sample into a chromatography stream.

The sample manager 600 further includes a solvent and diluent system fluidically connected to the automated needle system in order to provide solvent for the diluted sample injection and/or diluent and/or solvents for diluting the injectable substance or sample in the manner described. In particular, the sample manager 600 is shown including a first sample metering syringe 616 and a second diluent syringe 622 for metering diluent from a diluent reservoir 624 and degasser system 626. Each of the syringes 616, 620 may include respective valves 618, 622 for enabling or disabling flow thereto. The first sample metering syringe 616 may be connected to a solvent reservoir or bottle 630 and degasser system 632. A pressure transducer 634 is operably connected to the valve 618 of the first sample metering syringe 616. A second solvent reservoir or bottle 628 may be operably connected to the automated needle system and the first syringe drive system 604 and/or a second syringe drive system 606 thereof through a fluidic path including both a wash pump 636 and a solenoid valve 638. As described above, the wash pump may be configured to wash the dilution system components after each dilution sequence to enable reuse of the system.

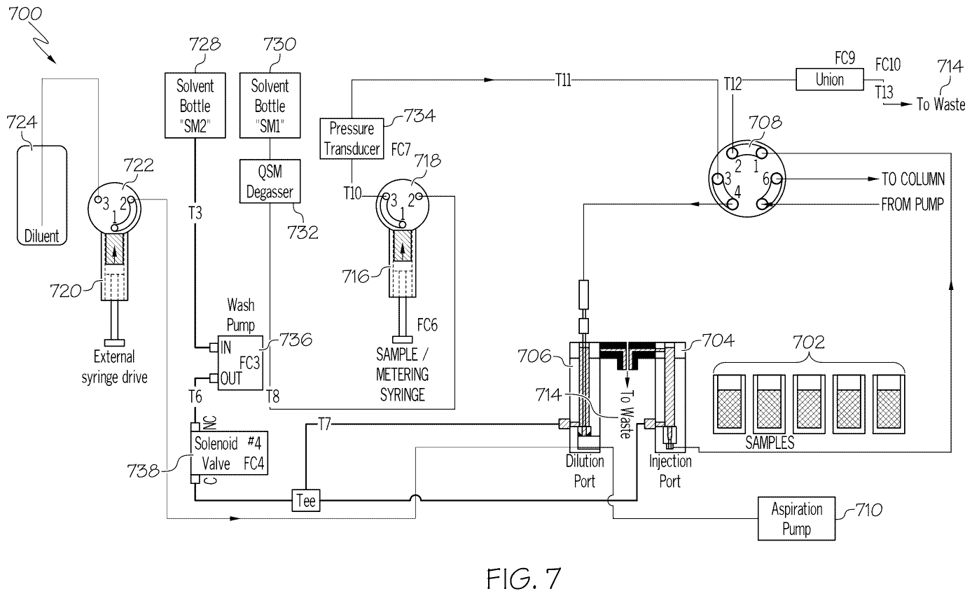

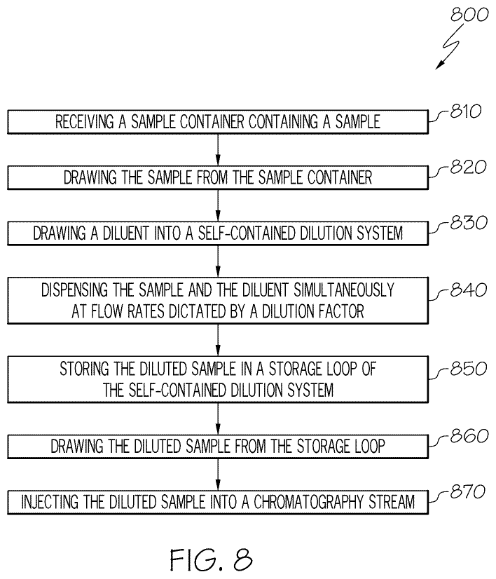

FIG. 7 depicts a schematic flow diagram of a sample manager 700 for a liquid chromatography system, in accordance with one embodiment. Like the sample manager 600, the sample manager 700 includes various components configured to process and/or dilute, without human intervention, one or more samples 702 using the methodology or workflow described herein. While not specifically shown, the sample manager 700 may include a receptor system configured to receive the original capped vials 702 or sample containers for processing therein.

The sample manager 700 includes a first syringe drive system 704 and a second syringe drive system 706. The first syringe drive system 704 may include a sample needle and puncture needle (not shown) for flow through needle injections into the liquid chromatography solvent flow for separation and/or analysis and/or detection. Thus, the sample needle of the first syringe drive system 704 may be configured to draw the injectable substance or sample from the original capped vial 702 or sample container. The second syringe drive system 706 maybe configured to draw diluent used during the diluting the injectable substance or sample.

The combination of the first syringe drive system 704 and the second syringe drive system 706 may be referred to herein as an automated needle system. Such a system may be configured to, in combination, dispense the sample and the diluent simultaneously at flow rates dictated by a dilution factor and/or dispense, by each of the sample needle of the first syringe drive 704 and the second syringe drive 706, the sample and the diluent sequentially at volumes dictated by the dilution factor.

The automated needle system may further include a port 708 in fluidic communication with the second syringe drive 706 for directing fluid flow. Moreover, as shown, the automated needle system and/or the sample manager 600 includes an aspiration pump 710 in fluidic communication with the second syringe drive 706 for aspirating the needle thereof. Still further, rather than a storage loop in fluidic communication with the automated needle system, the sample manager 700 includes a dilution tower 712 for storing and diluting the drawn injectable substance or sample and receiving diluent for dilution. The sample manager 700 system may be configured to move the dilution tower physically back and forth to promote mixing of the injectable substance or sample with the diluent within the dilution tower 712. The sample manager 700 may further include at least one waste channel 714 or path. The sample manager 700 and/or the automated system thereof may further be configured to draw the diluted sample from the dilution tower 712 and inject the diluted sample into a chromatography stream.

The sample manager 700 further includes a solvent and diluent system fluidically connected to the automated needle system in order to provide solvent for the diluted sample injection and/or diluent and/or solvents for diluting the injectable substance or sample in the manner described. In particular, the sample manager 700 is shown including a first sample metering syringe 716 and a second diluent syringe 722 for metering diluent from a diluent reservoir 724. Each of the syringes 716, 720 may include respective valves 718, 722 for enabling or disabling flow thereto. The first sample metering syringe 716 may be connected to a solvent reservoir or bottle 730 and degasser system 732. A pressure transducer 734 is operably connected to the valve 718 of the first sample metering syringe 716. A second solvent reservoir or bottle 728 may be operably connected to the automated needle system and the first syringe drive system 704 and/or a second syringe drive system 706 thereof through a fluidic path including both a wash pump 736 and a solenoid valve 738.

FIG. 8 depicts a method 800 for diluting an injectable substance or sample for liquid chromatography processing, in accordance with one embodiment. The method 800 is shown including a first step 810 of receiving, by a receptor of a liquid chromatography sample manager, an original capped vial or sample container containing an injectable substance or sample. A second step 820 includes drawing, by an automated needle system of the liquid chromatography sample manager, the injectable substance or sample from the original capped vial or sample container. The automated needle system includes a first syringe drive including a sample needle and a second syringe drive in various embodiments, where the second step 820 of drawing the injectable substance or sample from the original capped vial or sample container is performed by the sample needle of the first syringe drive.

The method 800 then includes a step 830 of drawing, by the second syringe drive, a diluent into a self-contained dilution system. The method 800 then includes a step 840 of dispensing, by each of the sample needle of the first syringe drive and the second syringe drive, the sample and the diluent simultaneously at flow rates dictated by a dilution factor.

A next step 850 of the method 800 includes storing, in a storage loop of the self-contained dilution system, the diluted injectable substance or sample. Finally, the method 800 includes a step 860 of drawing the diluted sample from the storage loop, and another step 870 of injecting the diluted sample into a chromatography stream.

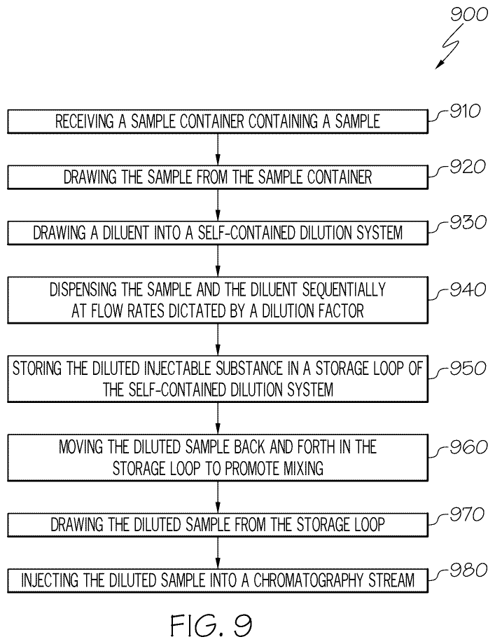

FIG. 9 depicts another method 900 for diluting an injectable substance or sample for liquid chromatography processing, in accordance with one embodiment. The method 900 is shown including a first step 910 of receiving, by a receptor of a liquid chromatography sample manager, an original capped vial or sample container containing an injectable substance or sample. A second step 920 includes drawing, by an automated needle system of the liquid chromatography sample manager, the injectable substance or sample from the original capped vial or sample container. The automated needle system includes a first syringe drive including a sample needle and a second syringe drive in various embodiments, where the second step 920 of drawing the injectable substance or sample from the original capped vial or sample container is performed by the sample needle of the first syringe drive.

The method 900 then includes a step 930 of drawing, by the second syringe drive, a diluent into a self-contained dilution system. The method 900 then includes a step 940 of dispensing, by each of the sample needle of the first syringe drive and the second syringe drive, the sample and the diluent sequentially at flow rates dictated by a dilution factor.

A next step 950 of the method 900 includes storing, in storage loop of the self-contained dilution system, the diluted injectable substance or sample. The method 900 then includes a step 960 of moving the diluted injectable substance or sample back and forth within the storage loop to promote mixing. Finally, the method 900 includes a step 970 of drawing the diluted sample from the storage loop, and another step 980 of injecting the diluted sample into a chromatography stream.

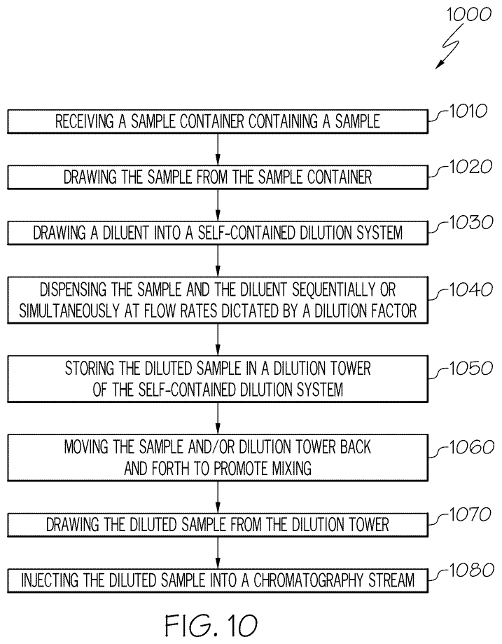

FIG. 10 depicts another method 1000 for diluting an injectable substance or sample for liquid chromatography processing, in accordance with one embodiment. The method 1000 is shown including a first step 1010 of receiving, by a receptor of a liquid chromatography sample manager, an original capped vial or sample container containing an injectable substance or sample. A second step 1020 includes drawing, by an automated needle system of the liquid chromatography sample manager, the injectable substance or sample from the original capped vial or sample container. The automated needle system includes a first syringe drive including a sample needle and a second syringe drive in various embodiments, where the second step 1020 of drawing the injectable substance or sample from the original capped vial or sample container is performed by the sample needle of the first syringe drive.

The method 1000 then includes a step 1030 of drawing, by the second syringe drive, a diluent into a self-contained dilution system. The method 1000 then includes a step 1040 of dispensing, by each of the sample needle of the first syringe drive and the second syringe drive, the sample and the diluent sequentially or simultaneously at flow rates dictated by a dilution factor. The step 1040 may be conducted in a dilution tower of the dilution system and/or automated system of the liquid chromatography sample manager in the method 1000, rather than a storage loop.

A next step 1050 of the method 1000 includes storing, in the dilution tower of the self-contained dilution system, the diluted injectable substance or sample. The method 1000 then includes a step 1060 of moving the dilution tower and/or the diluted injectable substance or sample back and forth within the dilution tower to promote mixing. Finally, the method 1000 includes a step 1070 of drawing the diluted sample from the dilution tower, and another step 1080 of injecting the diluted sample into a chromatography stream.

Still further, while the embodiments above describe a single dilution stage it is further contemplated to serially dilute the injectable substance and/or sample. For example, it is contemplated to serially dilute the sample by performing at least a first dilution sequence and a second dilution sequence, wherein the diluted sample is provided back into a dilution system after the first dilution sequence for the second dilution sequence. This serially diluting may be performed ad-nauseam to achieve extremely high dilution ratios. For example, dilution ratios of 10,000:1 are contemplated which may require multiple dilution sequences. Such sequences may include diluting a sample in a dilution container, extracting the diluted sample, emptying the dilution container and injecting the diluted sample back into the empty dilution container whereupon further dilution is conducted (either sequentially or simultaneously with diluent, as described hereinabove).

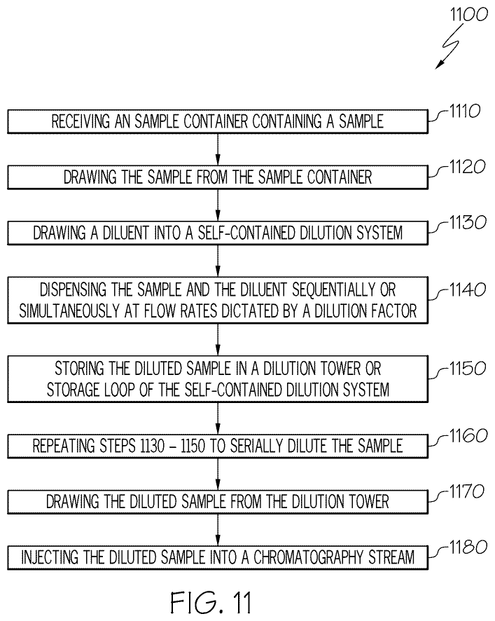

FIG. 11 depicts another method 1100 for diluting an injectable substance or sample for liquid chromatography processing, in accordance with one embodiment. The method 1100 includes a first step 1110 of receiving, by a receptor of a liquid chromatography sample manager, an original capped vial or sample container containing an injectable substance or sample. A second step 1120 includes drawing, by an automated needle system of the liquid chromatography sample manager, the injectable substance or sample from the original capped vial or sample container. The automated needle system includes a first syringe drive including a sample needle and a second syringe drive in various embodiments, where the second step 1120 of drawing the injectable substance or sample from the original capped vial or sample container is performed by the sample needle of the first syringe drive.

The method 1100 then includes a step 1130 of drawing, by the second syringe drive, a diluent into a self-contained dilution system. The method 1100 then includes a step 1140 of dispensing, by each of the sample needle of the first syringe drive and the second syringe drive, the sample and the diluent sequentially or simultaneously at flow rates dictated by a dilution factor. The step 1140 may be conducted in a dilution tower of the dilution system and/or automated system of the liquid chromatography sample manager in the method 1000, rather than a storage loop. A next step 1150 of the method 1000 includes storing, in the dilution tower or storage loop of the self-contained dilution system, the diluted injectable substance or sample.

The method 1000 then includes a step 1160 of sequentially repeating steps 1130-1150 above, in order to serially dilute the sample or injectable substance. It should be understood that the step 1160 may be repeatedly performed any number of times to serially dilute a sample or injectable substance. For example, the step 1160 may be repeated several times in the event highly diluted samples are necessary. Furthermore, after each dilution sequence, the dilution components may be washed thoroughly, as described herein above.

Finally, the method 1100 includes a step 1170 of drawing the serially diluted sample from the dilution tower, and another step 1180 of injecting the serially diluted sample into a chromatography stream.

While the above-described embodiments have depicted the process of receiving an injectable substance or sample within an original capped vail or sample container for processing, it should be understood that methods contemplated herein may further be configured to receive, dilute and/or process a batch of capped vials for automated processing by the sample manager. Thus, methods contemplated may include receiving, by a liquid chromatography sample manager, batch of original capped vials or sample containers, each containing an injectable substance or sample. Methods may include diluting, by an automated system of the liquid chromatography sample manager without human intervention, the batch. Such diluting may occur sequentially, for example. Such processing may include, for example, the removing one original capped vail from the batch at a time for processing. Methods may further include injecting, by the automated system of the liquid chromatography sample manager, the injectable substance or sample from at least one of the original capped vials or sample containers of the batch of original capped vials or sample vials into a chromatographic flow for analysis.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A method for performing liquid chromatography comprising:
receiving, by a receptor of a liquid chromatography sample manager, a sample container containing an sample;
drawing, by an automated needle system of the liquid chromatography sample manager, the sample from the sample container; and
diluting, by the automated needle system of the liquid chromatography sample manager, the sample using a dilution system that is self-contained within the sample fluidics of the liquid chromatography sample manager.

2. The method of claim 1, wherein the automated needle system includes a first syringe drive including a sample needle and a second syringe drive, wherein the drawing the injectable substance from the sample container is performed by the sample needle of the first syringe drive.

3. The method of claim 2, further comprising:
drawing, by the second syringe drive, a diluent used during the diluting the sample.

4. The method of claim 3, further comprising at least one of:
dispensing, by each of the sample needle of the first syringe drive and the second syringe drive, the sample and the diluent simultaneously at flow rates dictated by a dilution factor; and
dispensing, by each of the sample needle of the first syringe drive and the second syringe drive, the sample and the diluent sequentially at volumes dictated by the dilution factor.

5. The method of claim 4, further comprising:
storing, in a storage loop of the automated system of the liquid chromatography sample manager, the diluted sample.

6. The method of claim 5, further comprising:
moving the diluted sample back and forth within the storage loop to promote mixing.

7. The method of claim 6, further comprising:
drawing the diluted sample from the storage loop; and
injecting the diluted sample into a chromatography stream.

8. The method of claim 4, further comprising:
storing, in a dilution tower connected to at least one of the first syringe drive and the second syringe drive, the diluted sample.

9. The method of claim 8, further comprising:
moving the diluted sample and/or the dilution tower back and forth to promote mixing.

10. The method of claim 9, further comprising:
drawing the diluted sample, by at least one of the first syringe drive and the second syringe drive, from the dilution tower; and
injecting the diluted sample into a chromatography stream.

11. The method of claim 1, wherein the sample vial is an original capped vial and wherein the sample is an injectable substance.

12. The method of claim 1, wherein the diluting further comprises serially diluting the sample by performing at least a first dilution sequence and a second dilution sequence, wherein the diluted sample is provided back into the dilution system after the first dilution sequence for the second dilution sequence.

13. A liquid chromatography sample manager comprising:
a receptor configured to receive a sample container containing a sample; and
an automated needle system configured to, without human intervention:
draw the sample from the sample container; and
dilute the sample using a dilution system that is self-contained within the sample fluidics of the liquid chromatography sample manager.

14. The liquid chromatography sample manager of claim 13, wherein the automated needle system includes a first syringe drive including a sample needle and a second syringe drive, wherein the sample needle of the first syringe drive is configured to draw the injectable substance from the sample container.

15. The liquid chromatography sample manager of claim 14, wherein the second syringe drive is configured to draw a diluent used during the diluting the sample.

16. The liquid chromatography sample manager of claim 15, wherein the automated needle system is further configured to at least one of:
dispense, by each of the sample needle of the first syringe drive and the second syringe drive, the sample and the diluent simultaneously at flow rates dictated by a dilution factor; and
dispense, by each of the sample needle of the first syringe drive and the second syringe drive, the sample and the diluent sequentially at volumes dictated by the dilution factor.

17. The liquid chromatography sample manager of claim 16, further comprising:
a storage loop in fluidic communication with at least one of the first syringe drive and the second syringe drive, wherein the storage loop is configured to store the diluted sample.

18. The liquid chromatography sample manager of claim 17 further configured to move the diluted sample back and forth within the storage loop to promote mixing.

19. The liquid chromatography sample manager of claim 18, wherein the automated needle system is further configured to:
draw the diluted sample from the storage loop; and
inject the diluted sample into a chromatography stream.

20. The liquid chromatography sample manager of claim 16, further comprising:
a dilution tower connected to at least one of the first syringe drive and the second syringe drive, wherein the dilution tower is configured to receive and/or store the diluted sample.

21. The liquid chromatography sample manager of claim 20, wherein the dilution tower is configured to be moved back and forth to promote mixing of the diluted sample.

22. The liquid chromatography sample manager of claim 21, wherein the automated needle system is further configured to:
draw the diluted sample from the dilution tower; and
inject the diluted sample into a chromatography stream.

23. The liquid chromatography sample manager of claim 1, wherein the sample container is an original capped vial and wherein the sample is an injectable substance.

24. The liquid chromatography sample manager of claim 1, wherein the automated needle system is further configured to serially dilute the sample by performing at least a first dilution sequence and a second dilution sequence, wherein the diluted sample is provided back into the dilution system after the first dilution sequence for the second dilution sequence.

25. A liquid chromatography system comprising:
the liquid chromatography sample manager of claim 13; and
a solvent delivery system in fluidic communication with the liquid chromatography sample manager;
a chromatography column located downstream from the liquid chromatography sample manager; and
a detector located downstream from the chromatography column.
